(19) United States
(12) Patent Application Publication
(10) Pub. No.: US 2010/0318585 A1
(43) Pub. Date: Dec. 16, 2010

(54) METHOD FOR INSTALLING FAT FILE SYSTEM

(75) Inventors: LIANG HUA, Shenzhen City (CN); JIAN-FENG GUO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/557,265

(22) Filed: Sep. 10, 2009

(30) Foreign Application Priority Data
Jun. 11, 2009 (CN) 200910303147.7

(51) Int. Cl. G06F 12/00; G06F 12/02; G06F 17/30

(52) U.S. Cl. 707/823; 707/770; 707/822

(57) ABSTRACT

A method for a server installing a FAT file system on at least a client computer, the method includes the following steps. The subarea basic parameters of original files and data blocks stored in the server are read by a reading module. The subarea basic parameters of original files and data blocks are received and packed to an image file by the execution module. The FAT files in sub-directories are searched by the execution module and packed to the image file. The image file is received and transmitted to a file system installing module by the receiving module. The subarea basic parameters of original files and data blocks are separated from the image file and the basic data and data blocks are calculated by the file system installing module for storing them in memory and hard disc of the client computer.

### BACKGROUND

1. Technical Field

The present disclosure relates to a method for installing File Allocation Table (FAT) file system, and particularly to a method for a server installing a FAT file system on client computers.

2. Description of Related Art

File Allocation Table or FAT is a computer file system architecture now widely used on most computer systems and most memory cards, such as those used with digital cameras. It was developed by Bill Gates and Marc McDonald during 1976-1977. It is the primary file system for various operating systems including DR-DOS, FreeDOS, MS-DOS, OS/2 (v1.1) and Microsoft Windows (up until Windows Me). For floppy disks, it has been standardized as ECMA-107 and ISO/IEC 9293. Those standards include only FAT12 and FAT16 without long filename support; long filenames with FAT is partially patented. The FAT file system is relatively straightforward technically and is supported by virtually all existing operating systems for personal computers. This makes it a useful format for solid-state memory cards and a convenient way to share data between operating systems. Typically, the FAT file system is installed on client computers using an installation disc, which is inefficient and wastes much time and money.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of a system for using a server to install a FAT file system on client computers.

FIG. 2 is a block diagram of the system of FIG. 1.

FIG. 3 is a flow chart illustrating a method for using a server to install a FAT file system on client computers.

FIG. 4 is a flow chart illustrating a method for creating an image file of the FAT file system of the method of FIG. 3.

FIG. 5 is a flow chart illustrating a method for installing the FAT file system of the method of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

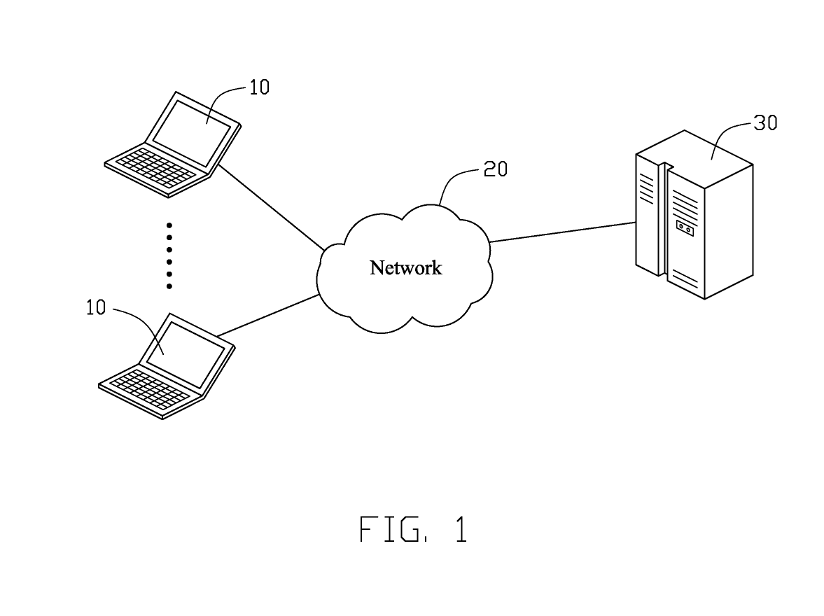

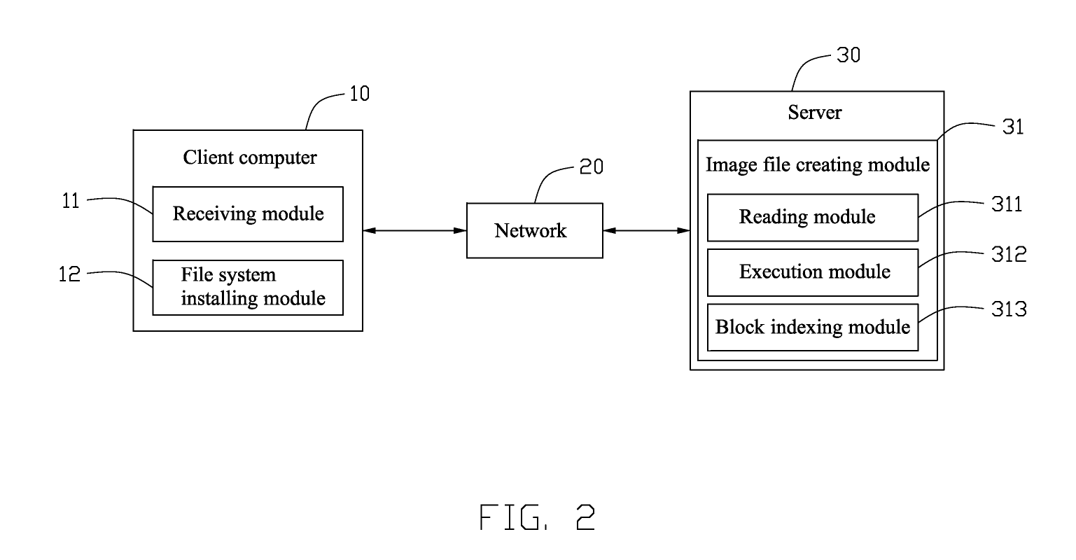

Referring to FIGS. 1 and 2, a system for using a server to install a FAT file system on client computers includes at least a server 30, a network 20, and a plurality of client computers 10. The plurality of client computers 10 is coupled to the server via the network 20. In this embodiment, the network 20 can be an intranet, the Internet or other types of networks. A Windows operation system can be installed on the server 30.

The server 30 includes an image file creating system 31 for creating an image file of the FAT file system. The image file includes subarea basic parameters of original files and data blocks. The subarea basic parameters of original files include size of the FAT file blocks, and number of reserved blocks and nodes. The data blocks include system data and file data. The image file creating system 31 includes a reading module 311, an execution module 312, and a block indexing module 313. The reading module 311 reads data and path of the data from the server 30, and transmits the data and path to the execution module 312. The execution module 312 packs the data and path to create an image file. The execution module 312 further searches FAT files in sub-directories, and packs the found FAT files to the image file. The block indexing module 313 searches the path for storing data blocks of the image file in the client computers 10. The server 30 transmits the image file to the client computers 10 via the network 20.

Each client computer 10 includes a receiving module 11, and a file system installing module 12. The receiving module 11 receives the image file from the server 30. The file system installing module 12 analyzes data and path of the data from the image file received by the receiving module 11 and stores data and path of the data on a hard disc of the client computer 10. Each client computer 10 includes a plurality of data clusters. In computer file systems, a cluster is the unit of disk space allocated for files and directories. In order to reduce the overhead of managing on-disk data structures, the file system does not allocate individual disk sectors, but contiguous groups of sectors, called clusters. On a disk that uses 512-byte sectors, a 512-byte cluster contains one sector, whereas a 4-kilobyte (KB) cluster contains eight sectors. The size of FAT sectors corresponding to the size of data clusters is indicated in the table below:

| size of FAT sector | size of data clusters |
|---|---|
| X < 8 GB | Y = 4K |
| 8 GB ≦ X < 16 GB | Y = 8K |
| 16 GB ≦ X < 32 GB | Y = 16K |
| X ≧ 32 GB | Y = 32K |

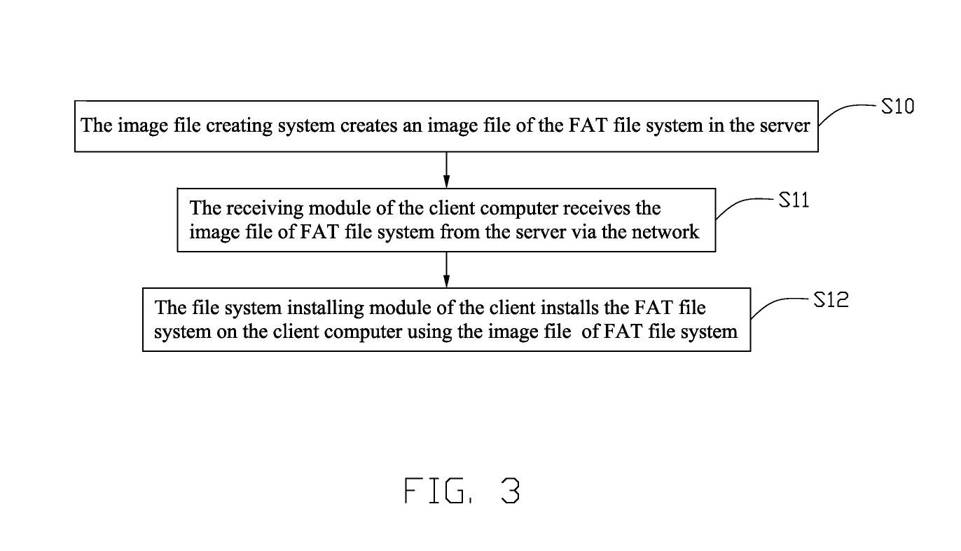

FIG. 3 is a flow chart illustrating a method for a server installing a FAT file system on client computers. Depending on the embodiment, certain steps described below may be removed, while others may be added, and the sequence of the steps may be altered. In one embodiment, the method for using a server to install a FAT file system on client computers utilizing the above-described system includes the following steps:
S10: the image file creating system 31 creates an image file of the FAT file system in the server 30;
S11: the receiving module 11 of the client computer 10 receives the image file of the FAT file system from the server 30 via the network 20;
S12: the file system installing module 12 of the client computer 10 installs the FAT file system on the client computer 10 using the image file of the FAT file system.

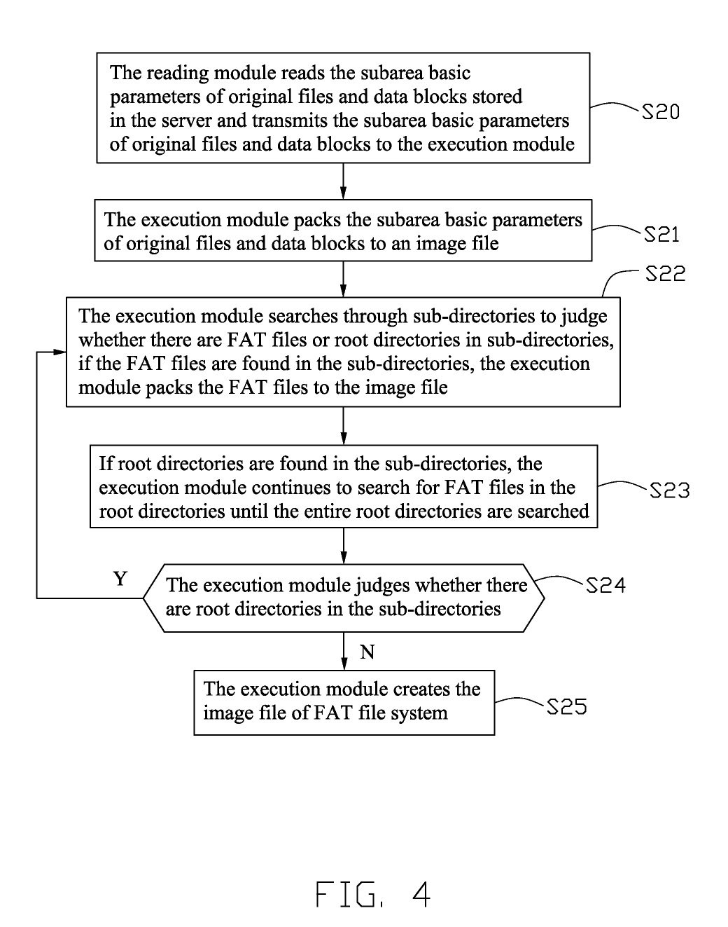

FIG. 4 is a flow chart illustrating a method for creating an image file of the FAT file system. Depending on the embodiment, certain steps described below may be removed, while others may be added, and the sequence of the steps may be altered. In one embodiment, the method for creating an image file of the FAT file system includes the following steps:
S20: the reading module 311 reads the subarea basic parameters of original files and data blocks stored in the server 30 and transmits the subarea basic parameters of original files and data blocks to the execution module 312;
S21: the execution module 312 packs the subarea basic parameters of original files and data blocks to an image file;
S22: the execution module 312 searches through sub-directories to judge whether there are FAT files or root directories in sub-directories, if the FAT files are found in the sub-directories, the execution module 312 packs the FAT files to the image file;
S23: if root directories are found in the sub-directories, the execution module 312 continues to search for FAT files in the root directories until the entire root directories are searched;
S24: the execution module 312 judges whether there are root directories in the sub-directories, if the root directories are found in the sub-directories, step S22 is repeated;
S25: if root directories are not found in the sub-directories, the execution module 312 creates the image file of FAT file system.

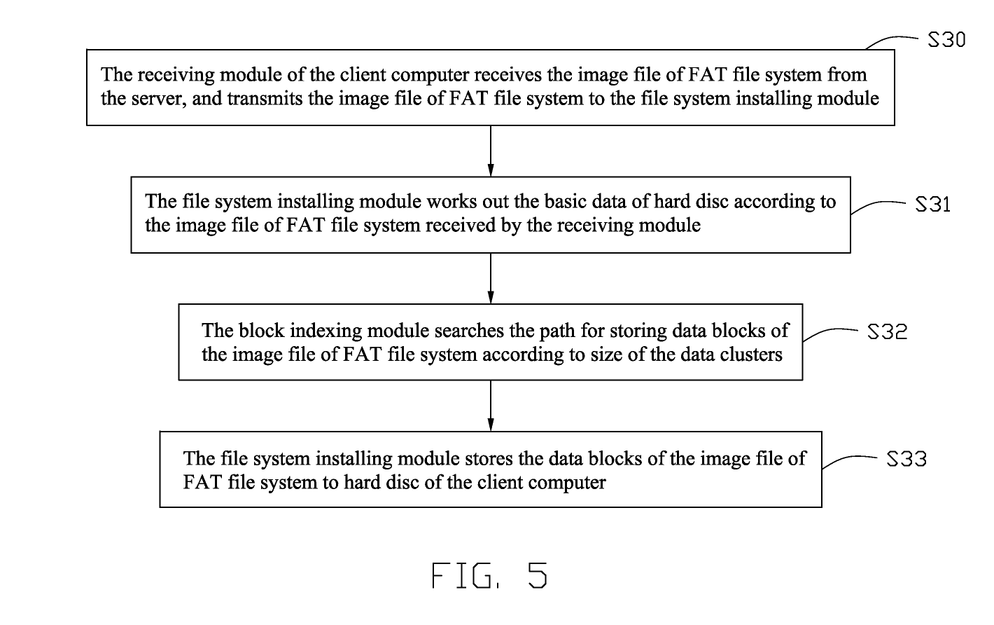

FIG. 5 is a flow chart illustrating a method for installing the FAT file system. Depending on the embodiment, certain steps described below may be removed, while others may be added, and the sequence of the steps may be altered. In one embodiment, the method for installing the FAT file system includes the following steps:
S30: the receiving module 11 of the client computer 10 receives the image file of FAT file system from the server 30, and transmits the image file of the FAT file system to the file system installing module 12;
S31: the file system installing module 12 calculates the basic data of hard disc on the client computer 10 according to the image file of FAT file system received by the receiving module 11;
S32: the block indexing module 313 searches the path for storing data blocks of the image file of FAT file system according to size of the data clusters;
S33: the file system installing module 12 stores the data blocks of the image file of FAT file system to hard disc of the client computer 10.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method for a server installing a FAT file system on at least a client computer, the method comprises the following steps:
reading the subarea basic parameters of original files and data blocks stored in the server by a reading module of the server;
receiving the subarea basic parameters of original files and data blocks, packing the subarea basic parameters of original files and data blocks to an image file, searching FAT files in sub-directories, and packing the found FAT files to the image file by an execution module of the server;
receiving and transmitting the image file to a file system installing module of the client computer by a receiving module of the client computer;
separating the subarea basic parameters of original files and data blocks from the image file and calculating the basic data and data blocks for storing in the client computer.

2. The method of claim 1, wherein if the FAT files are found in the sub-directories, the execution module packs the FAT files to the image file.

3. The method of claim 2, wherein if root directories are found in the sub-directories, the execution module continues to search for FAT files in the root directories until the entire root directories are searched.

4. The method of claim 1, wherein the subarea basic parameters of original files include size of the FAT file blocks and number of reserved blocks and nodes.

5. The method of claim 1, wherein the data blocks include system data and file data.

6. The method of claim 1, wherein if the client computer includes a plurality of data clusters, the data blocks of the image file are stored in the corresponding data clusters.

7. The method of claim 6, wherein a block indexing module of the server searches the path for storing data blocks of the image file in the corresponding data clusters of the client computer.
